(19) United States
(12) Patent Application Publication
(10) Pub. No.: US 2009/0017210 A1
(43) Pub. Date: Jan. 15, 2009

(54) METHODS AND SYSTEMS FOR COATING A MICRONEEDLE WITH A DOSAGE OF A BIOLOGICALLY ACTIVE COMPOUND

(76) Inventors: Alexander K. Andrianov, Belmont, MA (US); Alexander Marin, Newton, MA (US)

Correspondence Address: CARELLA, BYRNE, BAIN, GILFILLAN, CECCHI,;STEWART & OLSTEIN, 5 BECKER FARM ROAD, ROSELAND, NJ, 07068, US

(21) Appl. No.: 12/133,505

(22) Filed: Jun. 5, 2008

Related U.S. Application Data
(60) Provisional application No. 60/948,500, filed on Jul. 9, 2007.

(51) Int. Cl. B05D 5/00; B05D 1/18; B05C 11/10

(52) U.S. Cl. 427/256; 427/430.1; 118/712; 118/697

(57) ABSTRACT

Methodologies and systems are disclosed for coating one or more microneedles, particularly in a microneedle array, for administering a predetermined dosage of biologically active compound through the skin to a recipient. The microneedles of the array are each immersed into at least one reservoir of a fluid liquid formulation of the biologically active compound wherein the at least one reservoir receives a metered predetermined amount of the formulation that corresponds to the dosage to be coated on each microneedle. The microneedles are immersed into the at least one reservoir one or more times to consume the entire amount of formulation in the at least one reservoir such the consumed amount forms the coating comprising one or more layers comprising the predetermined dose on each microneedle. Various embodiments are disclosed for immersing the microneedles one needle at a time, one or more times into the reservoir, or in an array into corresponding reservoirs in one or more repetitive immersions. The reservoirs may be repetitively filled to the predetermined amount to produce the desired single dosage on a microneedle.

This application claims the benefit of provisional application Ser. No. 60/948,500 filed Jul. 9, 2007, incorporated by reference herein in its entirety.

This invention relates to methods and systems for forming a solid coating on microneedles of a microneedle array with a biologically active compound, such as a drug, vaccine or the like.

### BACKGROUND

Methods for coating of microneedles to form a solid drug containing formulations have been previously described. U.S. Pat. No. 6,855,372 describes a method of coating a liquid on microprojections without coating the liquid on the substrate using a roller, and immersing microprojections to a predetermined level. Gill, H. S. et al. Journal of Controlled Release, 117 (2007) 227-237, describes a process for fabricating the coating on microneedles via micro dip-coating them in a reservoir containing a cover to restrict access of liquid only to the microneedle shaft. Both of these methods rely on varying the number of contacts (dips) between the microneedle and the reservoir or roller to control a dosage of biologically active compound to be coated on the microneedle.

PCT application PCT/US06/23814 also describes methods for coating of microneedles to form a solid drug containing formulations, and is incorporated herein by reference in its entirety.

The present inventors recognize that these methods may not allow reliable and precise control of the dosage to be applied to the coating, since the amount of material to be deposited on the microneedle surfaces as a result of one contact (dip) can vary depending on the environment, surface characteristics of the microneedle, variations in the viscosity, surface tension, microneedle geometry, protein/polymer content in the formulation. In addition, the present inventors recognize that both prior art methods suggest the exposure of relatively large volumes of the formulation to the environment, which can result in increased drying and changes in the concentration of the formulation components in the production process.

The present inventors recognize a need for an improvement over these prior systems.

A method for coating a microneedle according to an embodiment of the present invention is for coating the microneedle with a predetermined dose of biologically active compound comprises forming at least one coating reservoir of a liquid coating formulation comprising the predetermined dose of the biologically active compound, the amount of formulation in the reservoir manifesting the predetermined dose being sufficient to form at least one layer of a coating on the microneedle and being substantially no more than the predetermined dose of the biologically active material; and immersing the microneedle into the liquid formulation in the at least one coating reservoir to form the at least one layer of coating on the microneedle, the immersing for substantially consuming the liquid coating formulation in the at least one coating reservoir.

The method according to one embodiment includes feeding the liquid formulation to a receptacle at least once to form the at least one coating reservoir.

In a further embodiment, the step of forming the at least one reservoir includes providing the liquid formulation of the biologically active compound for coating the at least one microneedle and then feeding the provided liquid formulation to a receptacle at least once to form the at least one coating reservoir.

In a further embodiment, a portion of the volume of the formulation manifesting a predetermined dose is fed into a receptacle, the microneedle is immersed into the receptacle to form a partial coating of the biologically active compound formulation from the portion, the feeding step is repeated in increments as necessary until the entire volume of the formulation manifesting the predetermined dose has been fed to the receptacle, and the immersing step is repeated after each feeding step until substantially all of the portions are consumed.

In a further embodiment, a step is included for forming the liquid formulation as an aqueous formulation.

In a further embodiment, a step is included forming the liquid formulation with a viscosity enhancer.

In a further embodiment, a step is included forming the liquid formulation with a polymer viscosity enhancer.

In a further embodiment, a step is included forming the liquid formulation with a water-soluble polymer.

In a still further embodiment, a step is included forming the liquid formulation with a water-soluble polymer selected from the group consisting of sodium carboxymethylcellulose, dextran, polyvinylpyrrolidone, polyphosphazene polyelectrolyte, and ethylcellulose.

In a further embodiment, a step is included forming the liquid formulation with a therapeutic protein biologically active compound.

In a further embodiment, a step is included forming the liquid formulation with a vaccine antigen biologically active compound.

In a further embodiment, a step is included forming the liquid formulation with a biologically active compound that is a combination of a vaccine antigen and vaccine adjuvant.

In a still further embodiment, a step is included forming the liquid formulation with a biologically active compound as a small drug.

In a further embodiment, a step is included forming the liquid formulation with a surfactant.

In a further embodiment, a step is included forming the liquid formulation with a slow release system.

In a still further embodiment, a step is included forming the liquid formulation with a slow release system comprising a microsphere based system.

In a further embodiment, said immersing step comprises immersing the at least one microneedle into the liquid formulation at least three times.

A system for coating a microneedle with a predetermined dose of biologically active compound comprises a first apparatus including at least one coating reservoir of a liquid coating formulation comprising the predetermined dose of the biologically active compound, the amount of formulation in the at least one coating reservoir manifesting the predetermined dose being sufficient to form at least one layer of a coating on the microneedle and being substantially no more than the predetermined dose of the biologically active material. A second apparatus is included coupled to the first apparatus for immersing the microneedle into the liquid formulation in the at least one coating reservoir to form the at least one layer of coating on the microneedle, the immersing for substantially consuming the liquid coating formulation in the at least one coating reservoir.

In a further embodiment, the first apparatus includes a liquid formulation feeding arrangement and a receptacle, the first apparatus for feeding the liquid formulation to the receptacle at least once to form the at least one coating reservoir.

In a further embodiment, the first apparatus at least one reservoir includes a receptacle and a further reservoir for providing the liquid formulation of the biologically active compound for coating the at least one microneedle and including a fluid feeding device for feeding the provided liquid formulation from the further reservoir to the receptacle at least once to form the at least one coating reservoir.

In a still further embodiment, the first apparatus includes a fluid coating receptacle for receiving the liquid formulation of the biologically active compound for forming the at least one coating reservoir and including a liquid metering arrangement for feeding a measured predetermined volume of the liquid formulation to the receptacle at least once, the predetermined volume manifesting the predetermined dose.

In a further embodiment, the first apparatus includes a first computer programmed control for feeding the formulation to a receptacle to form the at least one reservoir and a second computer programmed control is included for controlling an x-y-z manipulation device coupled to at least one of the first and second apparatuses for said immersing.

In a further embodiment, an array of microneedles is included, and wherein the first apparatus comprises an array of the at least one coating reservoir and the second apparatus comprises an arrangement for manipulating the array of microneedles for the immersion into the array of the at least one coating reservoir.

In a further embodiment, the first and second computer controls are coupled to control the time of feeding of the formulation with the control of the time of immersing.

### BRIEF DESCRIPTION OF THE DRAWING

FIG. 1 is a diagrammatic view of a system for coating a microneedle array according to one embodiment of the present invention;

FIG. 2 is a diagrammatic view of a system for coating a microneedle array according to a second embodiment of the present invention;

FIG. 3 is a diagrammatic elevation view illustrating certain principles for constructing the systems of FIGS. 1 and 2 according to an embodiment of the present invention;

FIG. 4 is a diagrammatic elevation view of system for coating a microneedle array according to a further embodiment of the present invention;

FIG. 5 is a plan view of microneedle array according to a further embodiment of the present invention;

FIG. 6 is a diagrammatic elevation view of system for coating a microneedle array according to a still further embodiment of the present invention;

FIG. 7 is an elevation schematic view of a microneedle and its associated coating reservoir according to one embodiment of the present invention;

FIG. 8 is an elevation view of a microneedle useful for explaining certain principles of the present invention;

FIG. 9 is a perspective view of a commercial prior art syringe forming an embodiment of a coating reservoir according to one embodiment of the present invention;

FIG. 10 is a front elevation view of a prior art panel for use on a control apparatus for operating the syringe of FIG. 9;

FIG. 11 is a perspective view of a commercial prior art apparatus employing the syringe of FIG. 9;

FIG. 12 is optical microscopic images of coated silicon microneedles;

FIG. 13 are optical microscopic images at 9× magnification of an uncoated (left), coated wet (center) and coated, dried (right) microneedle;

FIG. 14 is a graph showing the dependence of BSA (bovine serum albumin) loading on a microneedle as determined by high performance liquid chromatography (HPLC) on the amount of BSA supplied;

FIG. 15 is a graph showing the dependence of horseradish peroxidase (HRP) loading on a microneedle as determined by HPLC on the amount of HRP supplied in the liquid coating formulation to that microneedle;

FIG. 16 is a graph showing experimental enzymatic activity of HRP per microneedle versus the amount of HRP supplied in the liquid coating formulation to that microneedle;

FIG. 17 is a microphotograph scanning electron microscopy image of a coated microneedle at a magnification of 83× with a coating of BSA loading at 1 μg per microneedle according to example 1; and

FIG. 18 is a microphotograph of a scanning electron microscopy image of an array of microneedles at a magnification of 34× illustrating images of microneedles coated in accordance with an embodiment of the present invention.

### DETAILED DESCRIPTION OF THE PREFERRED EMBODIMENTS

Microneedles coated according to the embodiments of the present invention disclosed herein are provided with dosage coatings exhibiting improved dosage administering control and reproducibility over the dosages of biologically active compound to be delivered on the microneedle surface using the controlled dose dispensing (CDD) processes of the prior art as discussed in the introductory portion.

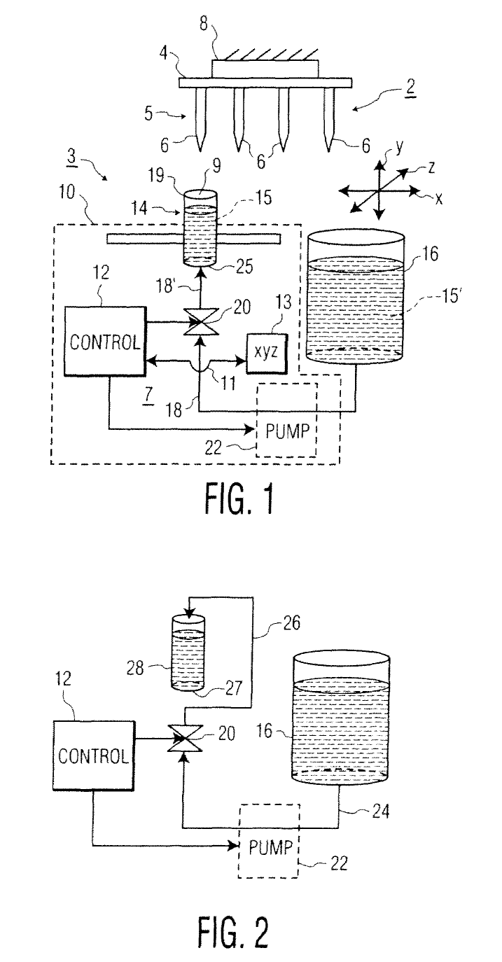

In FIG. 1, needle coating system 3 comprises microneedle array assembly 2 and coating fluid dispensing system 10. The assembly 2 comprises an array of microneedles 6 attached to a substrate 4. The substrate 4 may be of any suitable material. The dispensing system 10 coats the microneedles 6 with a coating that comprises a biologically active compound such as a drug or the like.

The array 5 of microneedles 6 are first coated with a liquid coating fluid by the system 10. The coating fluid is then dried to form a final hardened coated set of microneedles 6. The array of microneedles are attached to the skin of a recipient for penetration of the skin by the microneedles in a known manner to deliver the biologically active compound to the recipient through the skin of the recipient and such devices may be referred to as transdermal patches for example. The coatings disperse the biologically active compound into the flesh or dermis, or epidermis of the recipient to administer the biologically active compound. Such microneedles and their coatings are generally known in the art.

The microneedles 6 depend from the substrate 4, which together form the transdermal drug patch or the like for transferring a drug or biological active compound in a coating applied to the needles 6. The substrate 4 is releasably secured to a support 8, which is fixed in position in this embodiment. In an alternative embodiment, the needles via their support 8 may be positioned by an x-y-z positioning system for immersion into a reservoir of a coating formulation of a biologically active compound, the reservoir is filled with the formulation in one or a plurality of partial fillings, which plurality of fillings together manifest no more than the predetermined dose.

In FIG. 1, dispensing system 10 includes an x-y-z positioning system 13 coupled to control 12 via bus 11 and a coating fluid dispensing arrangement 7 also under the control of control 12 in this embodiment. In an alternative embodiment, the control 12 in practice may comprise two controls coupled by a timing system (not shown). A first of the two controls control the filing of the filling of the liquid formulation into the designated reservoir. The second control operates the x-y-z positioning system. The x-y-z positioning system in further embodiments may control the position of the microneedles for immersion into the corresponding reservoirs or may control the position of the reservoir(s) to receive the corresponding microneedle(s). The exemplary system 10 includes a coating fluid reservoir 14 comprising a coating fluid 15 in a receptacle 19. Receptacle 19 receives the needle coating fluid 15 from a supply reservoir 16 which stores coating fluid 15′ supplied to reservoir 14 via conduits 18, 18′ through coating fluid metering valve 20. The valve 20 is controlled (opened and closed) by control 12. The reservoir 14 contains a liquid formulation of a biologically active compound described below. The amount or volume of fluid 15 in the reservoir is fed to the reservoir in one or multiple filling steps manifesting the predetermined dose to be coated on a microneedle. This volume of fluid 15 is metered by control 12 via the valve 20. Control 12 is a programmed computer that contains instructions for operating the system 10 within the skill of one of ordinary skill in the programming art. This computer may be part of the computer forming the x-y-z control positioning of the microneedle(s) or reservoir(s) during the immersing step(s) to coat the formulation on the microneedle(s).

The amount of fluid metered to the reservoir 14 is exactly the amount (volume) needed to coat one microneedle 6 a predetermined dosage amount of the biological compound that will form the final needle 6 dry dosage coating. The reservoir 14 may hold a single dosage amount or may be fed multiple fluid dosage portions forming a single dosage amount for the final coating of one needle. The final microneedle coating dosage in the latter case is determined by x number of coating fluid portions repetitively filled into the reservoir 14 under control of control 12 and valve 20. In the multiple portion embodiment, the corresponding needle 6 then being coated is caused to be immersed into the reservoir 14 by the x-y-z positioning system via control 12 a predetermined number of times until substantially all of the predetermined amount or volume of reservoir 14 fluids are consumed to form the final coating thickness.

Valve 20 is opened and closed by control 12. Control 12 is computer operated in one embodiment in a dispensing system 10, which is commercially available and which embodiment will be described below. The control 12 in one embodiment may also automatically position reservoir 14 aligned with a selected needle 6 of the array 2 by the automatic x-y-z positioning system 13 included in the dispensing system 10. Control 12 also is programmed to automatically control the time that the valve 20 is open and thus meter the needed amount of fluid 15′ supplied from the supply reservoir 16 to the needle coating reservoir 14 to complete one coating dosage on a single needle. An optional pump 22 may be used to supply the fluid from the supply reservoir 16 to the valve 20 via conduit 18.

It should be understood that control 12 may comprise first and second controls (not shown) in corresponding first and second apparatuses. The first control meters the fluid supplied to reservoir 14 by controlling the operation of the valve 20. The second control operates the x-y-z positioning system for controlling either the position of the microneedle or the reservoir or both. The first control is in a first apparatus for supplying the reservoir 14 and the second control is in a second apparatus or coupled to the first and second apparatus portion forming an x-y-z positioning apparatus for immersing the microneedle into the reservoir 14. The first and second controls communicate with each other as to timing of their respective operations as being completed and for causing their respective operations to commence and terminate as a result of receipt of such timing signals.

It should be understood that the coated dosage on a needle represents a partial dosage of the biologically active material to be applied to a recipient. The combined coatings on all of the needles 6 of the array 5 form a full entire dosage to be administered by the array 5 by penetration into or through the skin of a recipient by way of example. The fluid 15′ may be supplied via optional pump 22 under operation of the control 12 in one embodiment or by gravity via fluid feed conduits 18, 18′ in a second embodiment. The reservoir 16 thus needs to be appropriately positioned relative to the position of the reservoir 14 for a gravity feed system.

In FIG. 1, the feed line 18′ feeds the reservoir 14 from the bottom providing a bottom fill inlet to the reservoir 14 for this purpose. However, this method of filling the reservoir 14 is optional as the reservoir may also be filled from the normally open reservoir top as shown in FIG. 2.

In FIG. 2, supply reservoir 16 is coupled to valve 20 by conduit 24. Computer operated control 12 via stored computer instructions including RAM and ROM, operates the valve 20 similar to the operation of control 12, FIG. 1. Identical reference numerals in the different figures correspond to identical parts. In this embodiment, however, the output conduit 26 of the valve 20 feeds the coating fluid to the microneedle receiving reservoir 28 via the top of the reservoir 28 rather than its bottom as in FIG. 1. Optional pump 22 or its equivalent, or gravity feed, also may be utilized.

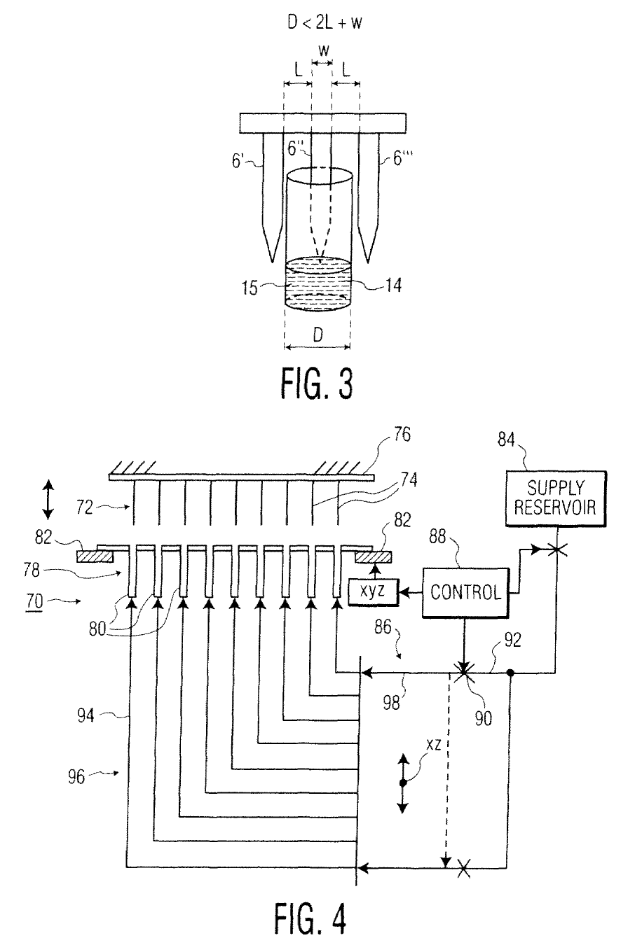

In FIG. 3, representative reservoir 14 has an outside diameter D. The spacing between adjacent exemplary microneedles 6′, 6″ and 6′″ in all directions is L. The needles 6′, 6″ and 6′″ are identical and may be stainless steel or titanium having diameters w. The outside diameter D of the reservoir 14 is less than 2L. This is so that the reservoir may fit in the interstitial space between alternate needles 6′ and 6′″ of the array 5 about the central needle 6″ being coated for all needles of the array 5, FIG. 1. The needles 6 have a diameter w that is smaller than the inside diameter of the reservoir 14 receptacle (based on a circular cylindrical reservoir 14) in order to be immersed into the coating fluid 15 stored in the reservoir 14. The reservoir 14 receptacle 19 in one embodiment is circular cylindrical, but may be other shapes in other implementations as desired.

The x-y-z positioning system 13, in the alternative, may be a manually operated system. In this case, a microscope (not shown) is used to visually align the reservoir 14 with each microneedle 6 of the array 2, FIG. 1, via the x-y-z manual positioning system corresponding to system 13. The reservoir 14 is raised by the positioning system 13 to immerse the aligned needle 6 into the fluid 15 sufficiently to fully use up all of the fluid with a single or multiple immersions of a selected microneedle 6 as needed for a given implementation. Depending upon the amount of fluid in the reservoir 14, a needle 6 may be inserted once or multiple times into that reservoir of coating fluid to provide a fully coated needle. Also, the reservoir 14 may, in certain implementations, be filled a number of times in order to provide a full dosage coating on the corresponding needle 6. Further, the reservoir bottom portion may contain a permanent predetermined amount of fluid that will not be coated onto a needle 6. This is to permit the immersed needles to be spaced above the bottom wall 25 of the reservoir 14, FIG. 1 (and wall 27 reservoir 28, FIG. 2). This positioning of the needle relative to the reservoir bottom wall is controlled by the positioning system 13.

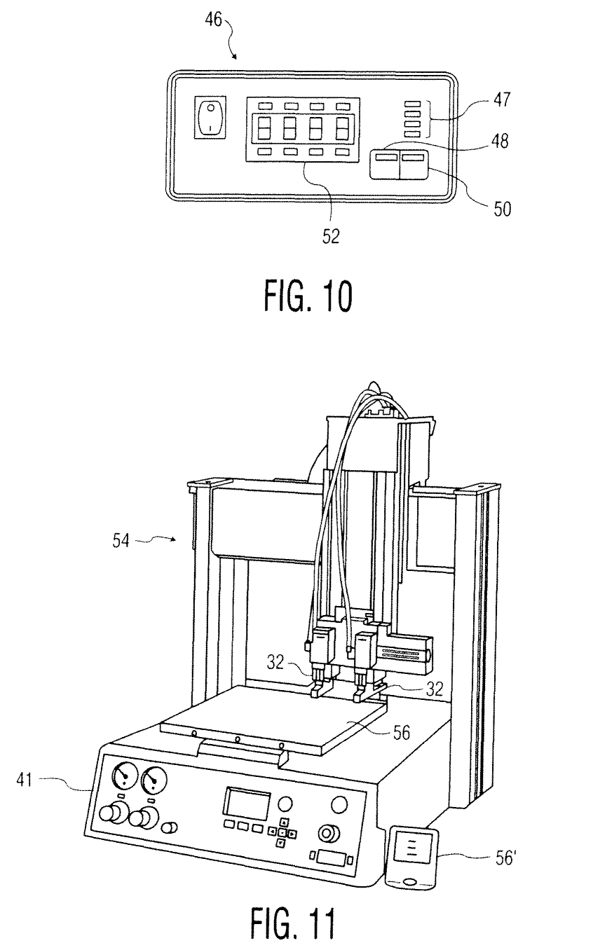

An x-y-z positioning system 13 in an automatic mode is operated by the programmed control 12 which selectively and accurately positions the reservoir 14 in predetermined horizontal and vertical x, y, and z positions to manipulate the reservoir 14. This action immerses the selected microneedle 6 of the array 5 for coating. The dispensing system 10 may be a commercially available system manufactured by EFD corporation such as its Ultra TT Automation Series, shown for example in FIGS. 9-11, and may also include its 741 series dispensing valves, shown for example in FIGS. 9 and 10, described below. The control 12 manipulates the reservoir 14 in any desired direction and distance to the needed accuracies in the x, y and z directions to align the corresponding coating fluid reservoir 14 with each selected needle 6. The microneedles 6 are immersed into the fluid 15 of the so positioned reservoir 14 to a desired depth in the fluid to fully consume the fluid in this embodiment, either with a single immersion or multiple immersions according to a given implementation.

The syringe needle 30, FIG. 9, forming the receptacle 19 of the reservoir 14, FIG. 1, may be of the type used, for example, in an embodiment of a commercially available dispensing system 54, FIG. 11. The fluid coating reservoir 14 receptacle 19 of FIG. 1, more particularly, may be formed by a prior art hollow syringe needle 30 of fluid dispensing device 32, FIG. 9. The device 32 comprises an air cylinder 34, which may be stainless steel, a fluid receiving body 36, which also may be stainless steel, having a chamber 38 for receiving the coating fluid from reservoir 16 (FIG. 1) to be dispensed to the needle 30. Device 32 also includes a fluid supply line 40 for supplying the coating fluid to the fluid receiving chamber 38 of the syringe body 36.

Device 32 includes an inlet fitting 42 for supplying the fluid from line 40 to the syringe chamber 38. The fluid is dispensed from chamber 38 via needle 30 which forms the coating fluid reservoir receptacle 19 of the reservoir 14, FIG. 1, for example. The needle 30 in this case is loaded with the coating fluid, which is not forced out of the needle 30, but stored therein to form the reservoir such as reservoir 14, FIG. 1. The device 32 further comprises a pressurized air line 44 for providing pressurized air to a piston (not shown) in cylinder 34, which piston forces fluid from the chamber 38 into the needle 30 for storing the coating fluid in the hollow syringe needle 30. The device 32 also includes an adapter 33 for attaching the needle 30 to the body 36 in fluid communication with the chamber 38. The adapter 33 is arranged to be releasably secured to the body 36 and is interchangeable with other adapters for receiving needles such as needle 30 of different dimensions. That is, different size needles 30 forming reservoirs of different capacities corresponding to microneedles of corresponding different dimensions may be used with the corresponding adapters 33.

The dispensing device 32 may operate millions of cycles without maintenance. The coating fluid is applied to needle 30 with accurate, close repetitive control via a computer programmed control in the system such as system 54, for example, which may provide the control 12, FIG. 1. The needle 30 stroke distance in direction 35 is set by a stroke setting device 37, FIG. 9, which is rotated in directions 39. The stroke distance controls the depth of penetration of the corresponding microneedle into the coating fluid of the reservoir, the microneedle being fixed in position at the time of its immersion into the reservoir which is displaced relative to the microneedle.

The device 32, FIG. 9, represents the valve 20, FIG. 1, which is operated by control 12 as commercially available as control 41, FIG. 11, for operating the device 32 of FIG. 9. In FIG. 1, the pump 22 schematically represents the piston (not shown) in the device 32, FIG. 9, which selectively periodically forces fluid into the needle 30 in periods and amounts as determined by the control of system 54, for example, or other similar commercially available system that may be used.

In FIG. 10, a representative control panel 46 of a commercially available dispensing system for operating control 12 (FIG. 1) includes function indicators 46 which include power, run, setup and cycle modes of the control 12 whose detailed operation is not described herein since this is a commercially available system. A pressure/time toggle 48 and an emergency stop switch 50 are also provided. The display 52 displays various parameters for operating the dispensing device 32, FIG. 9, including set time, timer bypass, pressure of air in air line 44 (FIG. 9), a teaching program stored in computer memory (not shown), a test cycle operated by the control 12, a purge mode for purging the coating fluid from the system and a reset control for resetting the device 32. There is a push button adjustment of a valve open time which controls the amount of coating fluid supplied to the needle 30, FIG. 9. The deposit size determined by controlling the amount of fluid supplied to the needle 32 (FIG. 9) and thus the reservoir 14 (FIG. 1) is programmed by pressing a PROGRAM button (not shown) in the setup mode. This commences selection of the amount of fluid supplied to the reservoir 14 FIG. 1 (needle 30 FIG. 9).

FIG. 11 depicts an exemplary automated x-y-z dispensing system 54 with integrated controllers for operating two dispensing devices 32 as shown as compared to manually operated systems or a single device 32 in other embodiments of other commercially available systems. The system 54 has an electronically controlled x-y-z positioning platform 56 for optionally aligning a microneedle array in an alternative embodiment to the reservoir needles of the two devices 32. The various gages, display and control knobs and buttons on the front face of the control unit 41 are explained in corresponding literature available with the commercially available system. The amount of fluid deposited into a reservoir needle 30 (FIG. 9) and thus reservoir 14 (FIG. 1) and the placement of the fluid deposit into the reservoir 14 (into alignment with a selected microneedle 6 (FIG. 1) are programmed into the system of FIG. 11 with an input device such as a personal data assistant (PDA) 56′ or teaching pendant.

A liquid formulation of fluid 15 is fed from the supply reservoir 16, FIG. 1, to the coating fluid receiving reservoir in an amount sufficient for the production of at least one layer of coating on the microneedle 6, FIG. 1, but not to exceed the desired dose of biologically active material for the coating on a microneedle. The microneedle is then brought into a temporary contact with the coating liquid formulation either by displacing the reservoir 14 or the microneedles or both, to produce a layer of coating on each microneedle 6. In one embodiment, the process is repeated until the coating fluid in the reservoir is consumed and a multilayer coating containing the desired dose of biologically active material is created on each microneedle 6.

Thus, after the coating fluid 15 formulation in the reservoir 14 is consumed, the amount of the biologically active compound deposited on each microneedle 6 of the array of needles is predetermined by this consumed amount to form the correct desired dosage for that needle 6. The coating amount thus is not controlled by the number of contacts or dips, as in the prior art systems, but only by dispensing a precise volume of the coating fluid to each microneedle. This approach prevents overdosing of the biologically active compound, and thus undesirable side effects, and also minimizes the development and validation work needed to establish a manufacturing process. The disclosed method of coating the microneedles can be performed one or more times for a given microneedle, when higher doses of biologically active compound are desirable, and multiple reservoirs of the formulation of the coating fluid may be required.

One of the advantages of the disclosed present coating methodology is that the volume of the liquid formulation fed to the microneedle is controlled at all times and thus the dose of biologically active compound for each microneedle is accurately controlled as well. Another advantage is that contrary to the previously described methods for coating microneedles with a biological active compound, a liquid drug or other biologically active compound containing formulation in a CDD process is not exposed to ambient atmospheric air for an undesirable lengthy period of time. This insures minimizing undesirable changes in the drug content, and in the viscosity of the coating fluid formulation, due to the drying or evaporation of the coating fluid liquids in the reservoir 14 formulation or the equivalent of reservoir 14 in other embodiments.

According to the method of the herein disclosed embodiments, the dose of the biologically active compound deposited on the microneedles is calculated as follows:

D_{b}=f×C_{b}×ΔV, (1)

wherein D_{b} is a predetermined dose of biologically active compounds on one microneedle, f is a number of feeds of portions of the coating fluid to the applicable fluid reservoir to form a final coating on the microneedle manifesting the predetermined dose, C_{b} is a concentration of a biologically active compound, and ΔV is a volume of a single feed.

The microneedles of the disclosed embodiments can be of any geometrical shape and constructed from the variety of materials, included but not limited to metals and their alloys, such as titanium, stainless steel, nitinol, gold, silicon, silicon dioxide, ceramics, and polymers, such as synthetic or natural, water-soluble and water-insoluble, biodegradable, organic or organometallic. Preferably, the microneedles are made from metal, most preferably, titanium.

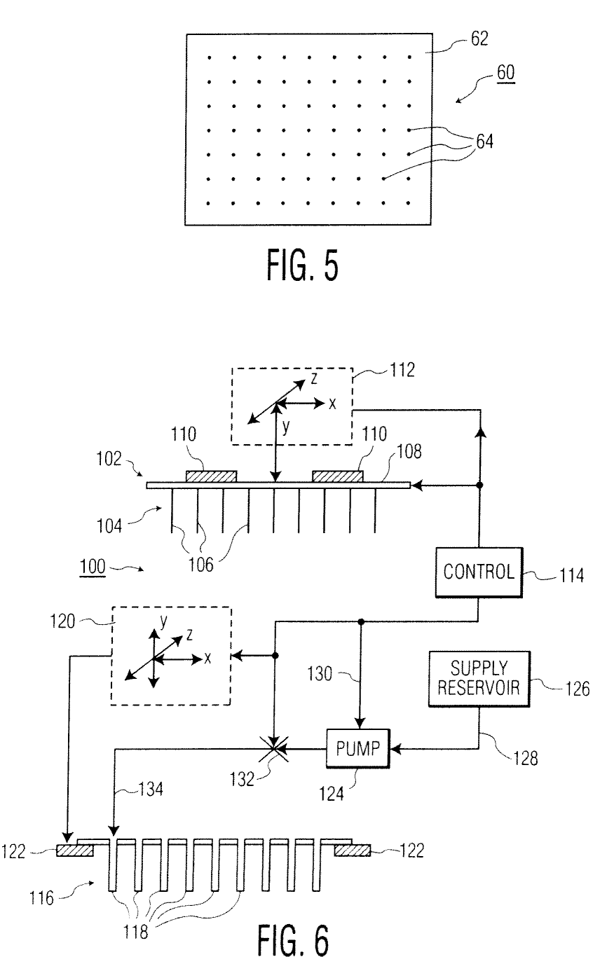

The metal microneedles can be prepared by a variety of techniques including laser cutting or chemical etching, including inductively coupled plasma dry etching. The microneedles can be then electropolished for a smoother surface or anodized, or otherwise surface modified to create the desired surface chemistry. In one embodiment, the length of the microneedles is between 100 and 1000 μm. In a most preferred embodiment, the length of the microneedle is between 300 and 600 μm. It is to be understood that the microneedles can be produced in the form of arrays. One such arrangement of needles is shown in FIG. 5. In FIG. 5, needle device 60 comprises a substrate 62. An array of microneedles 64 is attached to the substrate. 62. The array in this example comprises 63 microneedles 64.

Alternatively, the microneedles can be of any geometrical shape, size, and the array may contain a various number of microneedles. In a preferred embodiment, the array contains at least 50 microneedles. In such arrays microneedles are attached to the base of the array typically at an angle, preferably at 90° to the base substrate such as substrate 62, FIG. 5. The base substrate 62 of the array, for example, can be made of the same material as microneedles, such as titanium, or made of any other suitable material, such as plastic, rubber, or metal.

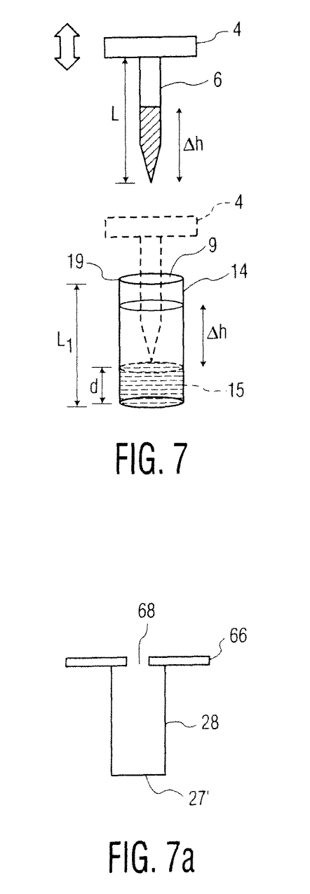

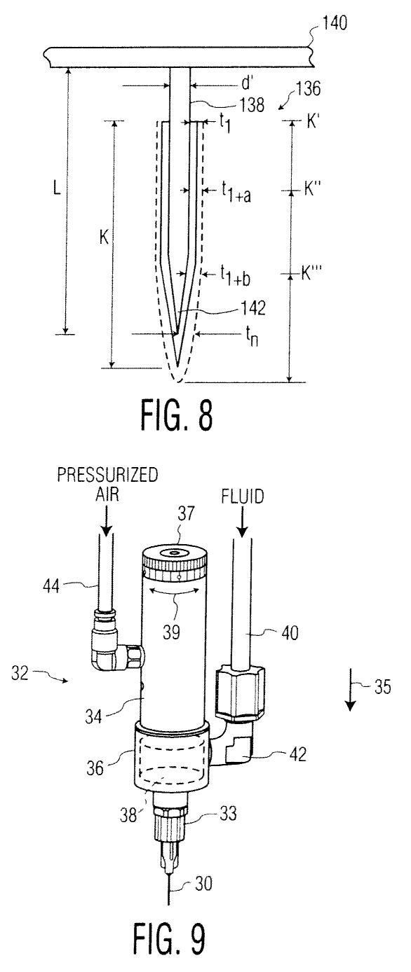

The coating reservoir such as reservoir 14, FIG. 1, can be of any geometrical form and comprise an opening 9, FIG. 1, that allows for the contact between each microneedle 6 and the liquid formulation fluid 15 containing the biologically active material. In the preferred embodiment, the coating reservoir 14 is of cylindrical shape. In the most preferred embodiment, the coating reservoir is of the shape similar to or conforming to the shape of the microneedle. The cylinder interior dimensions of the reservoir receptacle 19, FIG. 3, allow the microneedle to be immersed into contact with the liquid fluid formulation. In a preferred embodiment, the internal radius of the cylinder may be smaller than approximately the width w of the microneedle (FIG. 3) and the outside radius of the reservoir cylinder does not exceed the shortest distance between the microneedles, and most preferably, the outside radius is about half of the shortest distance between the microneedles along their length dimension L, FIGS. 7 and 8.

In FIG. 7, the length L, of the cylinder 19 of the reservoir 14 generally exceeds at least one third of the microneedle 6 length L, and most preferably, two thirds of the microneedle length. The volume of the coating fluid 15 in the reservoir 14 generally exceeds the volume of the single feed (ΔV). In yet another embodiment, the reservoir 14 includes a physical cover 66, FIG. 7a, containing an orifice 68 to allow the insertion of the microneedles 6 into the reservoir interior into the coating fluid liquid 15 formulation, but preventing the substrate 4, FIG. 7, of the microneedle from contacting with the coating liquid formulation fluid 15. The coating reservoir can be made of a variety of materials compatible with the liquid formulation of the biologically active compound, such as stainless steel, titanium, glass, or plastic.

It should be understood that a coating reservoir (not shown), in a further embodiment, may accommodate multiple microneedles, the entire array for example. In this case, the amount of the liquid formulation fluid fed to the reservoir 14 (f in the equation 1) is multiplied by the number of microneedles in the array. Subsequently, to obtain the dose of biologically active compound coated on the single microneedle (Db in equation 1) according to equation 1, the product f×C_{b}×ΔV, is divided by the number of microneedles in the array. The coating reservoir in this case has a physical cover such as cover 66, FIG. 7a, comprising an array of orifices corresponding to the number and position of the microneedles in the array. Such a cover allows the contact of the liquid formulation in the coating reservoir with the microneedles, but does not allow the substrate supporting member of the needle array to contact the formulation. This avoids or minimizes the loss of biologically active fluid. The needles of the array thus together form the desired total dosage to be administered by the needle array. Thus the dose on each needle in practice forms a partial dose which when combined with all needles of the needle array forms the final desired dosage to be administered.

The contact time between the microneedle and coating fluid formulation may vary depending on the formulation to be applied to the microneedle, the fluid viscosity, the geometry of the microneedle, stability of the biologically active component, and the solubility of the previous layer of the coating. In a preferred embodiment, the contact time of the coating fluid with the micro needle is between 1 and 10 seconds. The number of repetitive contacts between the microneedle and the coating fluid required for the full deposition of the coating onto the microneedle is dependent on the characteristics of the coating reservoir, the dose of drug or biologically active compound to be deposited, and properties of the formulation. In one embodiment, the number of such repetitive contacts is equal to the number of contacts needed for the full consumption of a single feed of the coating fluid to the reservoir such as reservoir 14, FIG. 1. Alternatively, the number of contacts may exceed the number of contacts needed for the full consumption of a single feed. Generally, the extent or the depth of contact remains the same during the coating process. Alternatively, the depth of contact can be varied, so that the thickness of the coating across the microneedle is varied.

In one embodiment, the contact between the microneedle and liquid coating fluid 15 formulation is followed by drying of the coating fluid coating on the microneedle(s). The drying process may be conducted by exposing the microneedle coating(s) to the air at ambient temperature. Alternatively, drying may be performed in a controlled environment, such as at elevated temperature, or in a controlled humidity, or in a nitrogen atmosphere. In one embodiment, the drying time is between 1 and 60 seconds. In the more preferred embodiment, the drying time is between 1 and 10 seconds. Of course, this drying time is a function of the formulation of the coating fluid and the environment in which the drying is occurring.

To supply the required feed of liquid formulation to the coating reservoir, various types of dispensing and microdispensing systems, such as mechanical, air, gravity, or vacuum driven systems can be used. Such systems may generally contain a valve, or similar device, to control the volume of the liquid formulation containing biologically active material being fed to the coating reservoir. In one embodiment, the feeding of liquid drug containing the fluid coating formulation may be periodic with a rate that can exceed the consumption of the coating fluid formulation in the microneedle coating step.

In yet another embodiment the feeding of formulation may be continuous with a feed rate that does not exceed the consumption of the coating fluid formulation. In another embodiment, the coating reservoir may be in continuous fluid communication with the supply reservoir, for example, in a gravity feed system wherein the source reservoir is positioned to automatically feed the desired amount of coating fluid to the reservoir. In this case, as the source reservoir fluid is depleted, a control system (not shown), such as a computer operated control, is provided to continuously monitor the fluid level in the source reservoir to insure it is at the desired position necessary to insure the coating reservoir receives the proper predetermined level of fluid therein. Also the amount of fluid in the coating reservoir may also be monitored by sensors (not shown) via a control to be sure the fluid is at the predetermined level corresponding to a given dosage prior to immersion of a microneedle.

In a further preferred embodiment, the coating fluid formulation is fed to the coating reservoir through an opening in the coating reservoir, which feeding may be controlled by a computer or manually controllable valve to provide the desired feed volume of the coating fluid to the reservoir. In yet another embodiment, the coating reservoir has no separate supply opening. The coating fluid formulation is supplied via a conduit from the supply reservoir to the coating fluid reservoir through the coating fluid reservoir top which is normally open to the ambient atmosphere using the microdispensing system described in FIGS. 1, 2, and 9-11 above. When the feed of the coating fluid to the coating fluid reservoir is completed, the fluid feed to that reservoir is halted until that fluid in that reservoir is consumed as described above.

To provide flow of the coating fluid to the selected microneedle(s) from the coating fluid formulation source to the coating fluid reservoir, a variety of positioning and micropositioning systems such as the types described above herein, or other commercially available systems, may be utilized. For example, in one embodiment, a manual three-dimensional (x-y-z) micropositioning system and stage can be used for position the microneedles and/or the coating fluid reservoir(s) according to a given implementation. In a most preferred embodiment, automated or motion control, such as computer software controlled, positioning is employed as described herein.

In FIG. 4, in a further embodiment, system 70 comprises an array 72 of microneedles 74 to be coated with a coating fluid formulation and attached to a substrate 76. The needles 74 are substantially identical and are in a symmetrical array wherein the spacing between the needles is substantially identical throughout the assembly. The needle array 72 is fixed in position.

A like array 78 of coating fluid reservoirs 80 are secured to a support 82. The reservoirs 80 may comprise reservoirs similar to the needles 30, FIG. 9, or other similar reservoir receptacles for receiving and coating the microneedles 74. The array 78 is substantially the same in dimensions between reservoirs in two orthogonal dimensions. Thus the needles 74 may all simultaneously be inserted into and immersed in a coating fluid stored in each reservoir 80. Each reservoir 80 receives an identical amount of coating fluid from the supply reservoir 84 via conduit system 86. The needles 74 are immersed into their corresponding reservoirs simultaneously.

Conduit system 86 comprises a control 88 which opens and closes valve 90 in conduit 92 to meter the correct predetermined amount of coating fluid to a corresponding reservoir 80. Control 88 also includes a programmed computer controlled x-y-z positioning arrangement. Conduit 92 is selectively coupled to each reservoir 80 via a corresponding reservoir input conduit 94 in an array 96 of conduits. Conduit 92 also comprises conduit section 98 which is displaceable in orthogonal two dimensional x-z directions. Section 98 is displaced to selectively couple the conduit 92 to a selected one of conduits 94. For example, the section 98 may comprise a displaceable dispensing device such as needle device 32, FIG. 9. The section 98 includes in this case a dispensing needle such as needle 30 or the like which is sealingly coupled to a selected conduit 94 by a sealing pliable valve flap and the like. The reservoirs 80 in array 78 in turn may comprise an array of needle-like receptacles similar to receptacle 19 formed by needle 30.

The conduits 94 are prefilled with coating fluid prior to filling the reservoirs 80. The reservoirs 80 are also partially filled at all times with the same amount of coating fluid. Pressurized fluid from the dispensing conduit system 86 under control of control 88 fills each reservoir 80 with an identical amount of coating fluid. The length of the conduits 94 may be relatively short, the drawing being not to scale for purposes of illustration. The conduits may be at any desired convenient orientation, the orientation of the figure being given only for illustration. For example, the conduits 94 need not be at right angles as shown, but may comprise short linear vertically oriented sections engaged in fluid communication by section 98 of the conduit system 86. In the alternative, the conduits 94 may be omitted and the conduit system 86 may engage the reservoirs in direct fluid communication to directly fill each reservoir 80 from section 98. The section 98 is displaced in an appropriately oriented xz direction to so engage the reservoirs 80.

The control 88 injects the same amount of fluid into each of the reservoirs 80. It does this by opening the valve 90 for a predetermined time period and applies the same pressure to the fluid in the conduit section 98 to inject the fluid into the reservoirs 80. All conduits for example may be vertical and aligned vertically with the reservoirs 80.

The advantage of the system 70 is that all microneedles are coated simultaneously providing for a more rapid coating arrangement than a system that coats the microneedles one at a time.

In the alternative to a single section 98 and conduit 92 that is displaced to position section 98 in alignment with each conduit 94 as discussed above, the sections 98, valves 90 and conduits 92 may be arranged in a further embodiment in an identical array (not shown) corresponding to the array of conduits 94 and array of reservoirs 80 and coupled to the array 78 of reservoirs 80 simultaneously. In this embodiment, there is a corresponding array of valves 90, each valve 90 being associated with a corresponding conduit section 98 of the array of conduit sections. Control 88 opens and closes these valves 90 in the array sequentially to apply the same amount of coating fluid formulation to each reservoir 80.

The fluid in the conduits 92 in this case is pressurized to cause an identical amount of fluid to be injected into each conduit 94 when the valve 90 is opened and thus into the corresponding reservoir 80. Control 88 controls the operation of the array of the valves 90 in the specified sequence. Such operation of the valves 90 in sequence increases the speed in which the reservoirs 80 can be filled. The timing of the valve opening and pressure can be determined empirically and controlled by a programmed controller (not shown). Sensors (not shown) can also be used to sense the amount of fluid in each reservoir such as optical sensors used in conjunction with optically transparent reservoirs 80 or flow sensors that can be used to sense the fluid flowing in the conduits such as conduit 92 or 94, for example.

FIG. 6 illustrates another embodiment wherein the coating fluid is filled in the coating reservoirs from the top. This is somewhat similar to the embodiment of FIG. 2. Needle coating system 100 comprises a microneedle array assembly 102 comprising an array 104 of microneedles 106 secured to a substrate 108. The assembly 102 is releasably attached to a movable platform 110 of an x-y-z positioning system 112 that is part of the system 100. The system 112 is operated by programmed control 114. The needles 106 of the array 104 are identical and are in a symmetrical identical spacing as are the microneedles in all of the embodiments disclosed herein.

An array 116 of reservoirs 118 is attached to a further x-y-z positioning system 120 via support 122. The reservoirs 118 may be identical to reservoirs 14 described above in connection with FIG. 1 except they are filled from the top, and not the bottom. The control 114 operates a pump 124 via line 130. Pump 124 receives the coating fluid from the supply reservoir 126 via conduit 128. The control 114 also operates valve 132 to meter the coating fluid via conduit 134 to selected ones of the reservoirs 118 of the array 116. It should be understood that the pump 124, valve 132 and the conduit 134 in one embodiment may be represented by the device 32, FIG. 9 and the control 114 may be represented by the control of system 54, FIG. 11. The x-y-z positioning system 112 may be represented by the platform 56 controller of the system 54, FIG. 11. The x-y-z positioning system 120 for positioning the reservoirs to receive the coating fluid from the conduit 134 may also be controlled by an appropriately programmed system such as the controller of system 54 or other x-y-z positioning controllers that are commercially available.

In operation, the reservoirs 118 of the array 116 are filled with the predetermined amount of coating fluid one reservoir at a time until the entire array is filled. At this time the array 104 of microneedles are positioned by the positioning system 112 to simultaneously insert the microneedles into the corresponding reservoirs 118. The number of times the needles 106 are inserted and the depth of insertion are determined by the program of control 114. The number of insertions and the amount of coating fluid in the reservoirs is determined for each implementation in a manner as described above for the other embodiments. An optional cover such as cover 66 shown in connection with FIG. 7a may also be used in this embodiment. In this case the optional cover has an array of apertures (not shown) corresponding the array 116 of reservoirs 118 (FIG. 6).

In FIG. 7, the exemplary microneedle 6 is coated to a height of Δh. This height may be less than the depth d of the fluid in the reservoir receptacle 19. This is to allow the needle 6 to be spaced above the bottom wall 27′. The microneedles 6 may be inserted into the stationary reservoir 14 or the reservoir 14 may be lifted to immerse the stationary microneedles into the fluid of the reservoir 14.

In FIG. 8 a microneedle assembly 136 comprises microneedle 138 attached to and depending from a substrate 140. the needle 138 has a diameter d′ and a length L. The needle 138 is immersed into a coating fluid multiple times but to different depths among the various immersions to provide multiple coating layers. An initial layer of a coating 142 (solid line) is provided by the initial immersion(s). That is, the initial coating is provided by immersing the microneedle 138 into the coating fluid the same depth k, one or more times. The microneedle 138 is then immersed into the coating fluid a plurality of different depths k′, k″, k′″ etc. to provide a gradually thickening coating in layers from the thinner coating thickness to at the region nearest the substrate 140 to increasing thicknesses t₁₊ₐ, t_{1+b}, to tₙ, the latter of which is at the tip 142 of the needle 138. This ensures the proper administration of the desired dosage since most of the biologically active compound will be at the needle tip 142 region where the chance of being distributed and administered is greatest due to its contact with a higher concentration of body fluids.

In one embodiment the formulation containing a biologically active compound may also comprise a viscosity enhancer, such as a polymer. Generally, various types of polymers can be used for the purpose described herein, such as polymers of synthetic, semi-synthetic, or natural origin. The polymers can be linear, branched, brush- or comb-like; copolymers can be random, alternate, block or graft copolymers.

In a further embodiment, the polymers may be water-soluble polymers. Typical examples of such polymers are polyvinylpyrrolidone, poly(vinyl alcohol), poly(ethylene glycol), poly(ethylene oxide), polyoxymethylene, poly(hydroxyethyl methacrylate), dextran, sodium carboxymethylcellulose, hydroxyethylcellulose, hydroxypropylcellulose, alginic acid, chitosan, poly(glutamic acid), hyaluronic acid, poly(isobutylacrylamide), poly(ethylenimine), polyphosphazenes, especially those that comprise pyrrolidone, ethylene oxide, and carboxylic acid containing side-groups, and copolymers thereof. In the most preferred embodiment, the polymers are either biodegradable or of sufficiently low molecular weight to be removed from the body through renal clearance.

In yet another embodiment, the polymers can be hydrophobic, most preferably biodegradable hydrophobic polymers. Examples of hydrophobic polymers are poly(hydroxyvalerate), poly(lactide), poly(glycolide) polycaprolactone, poly(lactide-co-glycolide), poly(hydroxybutyrate), poly(hydroxybutyrate-co-valerate), polydioxanone, polyorthoester, polyanhydride, poly(vinyl methyl ether), polyvinylidene chloride, poly(butyl methacrylate), poly(ethylmethacrylate), poly(vinylidene fluoride), poly(trimethylene carbonate), poly(iminocarbonate), and other derivitized polyurethanes, polyphosphazenes, such as polyaminophosphazenes, especially those with amino acid and imidazol side groups, and poly(organosiloxanes).The liquid coating fluid formulation may also include one or more pharmaceutical acceptable and/or approved additives (excipients), antibiotics, preservatives, diluents and stabilizers. Such substances may be water, saline, glycerol, ethanol, wetting or emulsifying compounds, pH buffering substances, polyols, such as trehalose, surfactants or the like. Typically useful surfactants for formulations include polyoxyethylene derivatives of fatty acid partial esters of sorbitol anhydrides such as Tween 80, Tween 20, Pluronics, Polyoxynol 40 Stearate, Polyoxyethylene 50 Stearate and Octoxynol. The usual concentration is form 0.01% to 10% (w/v). A pharmaceutically acceptable preservative can be employed to increase the shelf-life of the compositions. Benzyl alcohol may be suitable, although a variety of preservatives including, for example, Parabens, thimerosal, chlorobutanol, or benzalkonium chloride may also be employed. A suitable concentration of the preservative will be from 0.02% to 2% (w/v) although there may be appreciable variation depending upon the agent selected.

The coated microneedles of the disclosed embodiments are useful in the transport of biologically active compounds across the biological barriers in humans, animals, or plants. These barriers generally include skin or parts thereof, such as epidermis, mucosal surfaces, blood vessels, and cell membranes. In one embodiment, the microneedle devices are useful for the delivery of biologically active compounds into human skin, most preferably to the epidermis. They typically contain skin piercing elements to penetrate stratum corneum and can be applied with an applicator to maintain the desired pressure and time of the application. In the alternative, the microneedles may deliver the biologically active compound to the dermis.

In one embodiment coated microneedle devices of the disclosed embodiments are applied to the skin for a period of time required for the coating to dissolve, disintegrate, erode, degrade, swell, or undergo other physical, chemical, or biological changes to release the biologically active compound. The coating may be water-soluble, so it may quickly dissolve upon the contact with body fluids. The preferred dissolution time is between 1 seconds and 60 minutes. The most preferred dissolution time is between 1 and 600 seconds.

The polymers of the coating fluid formulation are selected to provide for a controlled release of the biologically active compound in an aqueous environment. The rate of release of the biologically active compound may be modulated through the selection of the polymer with the desired rate of dissolution or degradation. Generally, water-soluble polymers, especially those with low molecular weight will provide for the fast release of the biologically active compound. Hydrophobic biodegradable polymers will generally provide for the slow release of the biologically active compound.

Various polymers can be combined or assembled in the same coating to provide for a modulated release profile, such as slow or pulsatile, of the biologically active compound. They can be formulated in multilayer structures as described above in connection with embodiment of FIG. 8 or they can be first processed in micro- or nanospheres, micro- or nanofibers, and then added to the fluid coating formulation. Micelles, liposomes, nanotubes, dentritic polymers, or any other macromolecular assemblies can be also used to modulate the release profile. Water-soluble polymers can be cross-linked, covalently or ionically, to form a hydrogel, so that the rate of release can be controlled through the diffusion of biologically active compound. The rate of diffusion is varied through the cross-linking density, polymer content, and morphology of the hydrogel.

In one embodiment, the microneedle can be coated with the formulation containing water-soluble polymer first, and then the formulation containing hydrophobic biodegradable polymer and the biologically active compound, so that two layers are formed on the microneedle. Upon exposure of such coating to the environment, such as fluids of the epidermis, it can detach from the surface of the microneedle leaving the material containing biologically active compounds in the skin after the microneedles are removed to affect slow release of such compound. In yet another embodiment, the microneedles of the array can be coated with different formulations, so that various release profiles are achieved through the application of a single microneedle array to the skin.

Pharmaceutically active or bioactive substances which may be included in the resulting preparation are listed in the Physicians' Desk Reference, 57th Edition (2003), and include allergens, amebicides and trichomonacides, analeptic compounds, analgesics, anorexics, antacids, antihelmintics, antialcohol preparations, antiarthritics, antiasthma compounds, antibacterials and antiseptics, antibiotics, antiviral antibiotics, anticancer preparations, anticholinergic drug inhibitors, anticoagulants, anticonvulsants, antidepressants, anti-diabetic compounds, anti-diarrheals, anti-diuretics, anti-enuresis compounds, antifibrinolytic compounds, antifibrotics (systemic), antiflatulents, antifungal compounds, antigonadotropin, antihistamines, antihyperammonia compounds, anti-inflammatory compounds, antimalarials, antimetabolites, anti-migraine preparations, antinauseants, antineoplastics, anti-obesity preparations, anti-parasitics, anti-parkinsonism drugs, antipruritics, antipyretics, antispasmodics and antichloinergics, antitoxoplasmosis compounds, anti-tussives, anti-vertigo compounds, antiviral compounds, bone metabolism regulators, bowel evacuants, bronchial dilators, calcium preparations, cardiovascular preparations, central nervous system stimulants, cerumenolytics, chelating compounds, choleretics, cholesterol reducers and anti-hyperlipemics, colonic content acidifiers, cough and cold preparations, decongestants, expectorants and combinations, diuretics, emetics, enzymes and digestants, fertility compounds, fluorine preparations, galactokinetic compounds, geriatrics, germicides, hematinics, hemorrhoidal preparations, histamine II, receptor antagonists, hormones, hydrocholeretics, hyperglycemic compounds, hypnotics, immunosuppressives, laxatives, mucolytics, muscle relaxants, narcotic antagonists, narcotic detoxification compounds, ophthalmological osmotic dehydrating compounds, otic preparations, oxytocics, parashypatholytics, parathyroid preparations, pediculicides, premenstrual therapeutics, psychostimulants, quinidines, radiopharmaceuticals, respiratory stimulants, salt substitutes, scabicides, sclerosing compounds, sedatives, sympatholytics, sympathomimetics, thrombolytics, thyroid preparations, tranquilizers, tuberculosis preparations, uricosuric compounds, urinaryT acidifiers, urinary alkalinizing compounds, urinary tract analgesic, urological irrigants, uterine contractants, vaginal therapeutics and vitamins and each specific compound or composition listed under each of the foregoing categories in the Physicians' Desk Reference.

They include, but not limited to water-soluble molecules possessing pharmacological activity, such as a peptide, protein, enzyme, enzyme inhibitor, antigen, cytostatic compound, anti-inflammatory compound, antibiotic, DNA-construct, RNA-construct, or growth factor. Examples of therapeutic proteins are interleukins, albumins, growth hormones, aspariginase, superoxide dismutase, monoclonal antibodies. Biological compounds include also water-insoluble drugs, such as camptothecin and related topoisomerase I inhibitors, gemcitabine, taxanes and paclitaxel derivatives. Other compounds include, for example, peptides, including peptidoglycans, as well as anti-tumor compounds, cardiovascular compounds such as forskolin; anti-neoplastics such as combretastatin, vinbiastine, doxorubicin, maytansine; anti-infectives such as vancomycin, erythromycin: anti-fungals such as nystatin, amphotericin B, triazoles, papulocandins, pneumocandins, echinocandins, polyoxins, nikkomycins, pradimicins, benanomicins; anti-anxiety compounds, gastrointestinal compounds, central nervous system-activating compounds, analgesics, fertility or contraceptive compounds, anti-inflammatory compounds, steroidal compounds, anti-urecemic compounds, cardiovascular compounds, vasodilating compounds, vasoconstricting compounds, parathyroid hormone (PTH), Erythropoietin (EPO) and the like.

The vaccine antigens of the invention can be derived from a cell, a bacteria or virus particle or a portion thereof, or of a synthetic origin. The antigen can be a protein, peptide, polysaccharide, glycoprotein, glycolipid, DNA, virus like particle, or combination thereof which elicits an immunogenic response in a human; or in an animal, for example, a mammal, bird, or fish. The immunogenic response can be humoral, mucosal, or cell mediated. Examples are viral proteins, such as influenza proteins, human immunodeficiency virus (HIV) proteins, Herpes virus proteins, and hepatitus A and B proteins. Additional examples include antigens derived from rotavirus, measles, mumps, rubella, and polio; or from bacterial proteins and lipopolysaccharides such as Gram-negative bacterial cell walls. Further antigens may also be those derived from organisms such as Haemophilus influenza, Clostridium tetani, Corynebacterium diphtheria, and Nesisseria gonhorrhoae.

The fluid coating formulation of the present invention may also include vaccine adjuvants or immunostimulating compounds—compounds, which, when added to the antigen, enhance an immune response to the antigen in the recipient host. They may also include immune response modifying compounds, compounds that act through basic immune system mechanisms known as toll like receptors to induce selected cytokine biosynthesis. Typical examples of adjuvants and immune modulating compounds include aluminum hydroxide, aluminum phosphate, squalene, Freunds adjuvant, certain poly- or oligonucleotides (DNA sequences), such as CpG, Ribi adjuvant system, polyphosphazene adjuvants such as poly[di(carboxylatophenoxy)phosphazene] (PCPP) and poly[di(carboxylatoethylphenoxy) phosphazene] (PEPP), MF-59, saponins, such as saponins purified from the bark of the Q. saponaria tree, such as QS-21, derivatives of lipopolysaccharides, such as monophosphorlyl lipid (MPL), muramyl dipeptide (MDP) and threonyl muramyl dipeptide (tMDP); OM-174; non-ionic block copolymers that form micelles such as CRL 1005; and Syntex Adjuvant Formulation.

In yet another embodiment the coating fluid formulation may contain compounds useful in cosmetics and cosmeceutical applications. Such compounds may include proteins, such as collagen, Clostridium antigen or toxin, oils, peptides, etc.

In yet another embodiment the coating fluid formulation may contain materials useful in the detection of biological compounds in body fluids. Such materials can act as absorbent of biological compounds for their subsequent detection, such as superabsorbent polymers, or used as reagents, such as enzymes, for the detection of biological compounds.

The present invention is exemplified by, but not limited to, the following examples.

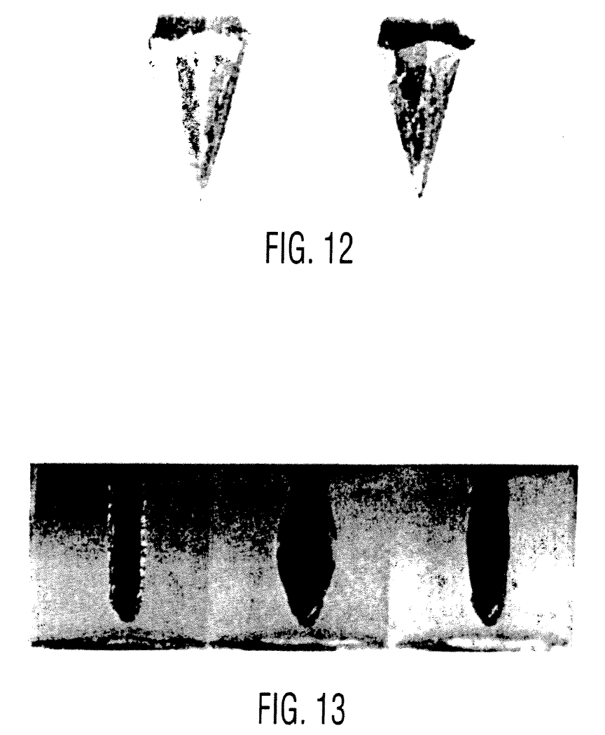

FIG. 12 illustrates optical microscopy images of coated silicon microneedles. The needles are coated with an aqueous formulation from a coating fluid containing 10% (w/v) of ovalbumin, 1% (w/v) Dextran, 0.6% (w/v) Tween-20 (ambient temperature, deionized water).

FIG. 13 illustrates optical microscopy images at 9× magnification of an uncoated microneedle (left image), a coated and wet microneedle (center image), and a coated, dried coating microneedle (right image) after 10 pulse volumes. Titanium microneedles were coated using an aqueous formulation of a fluid coating containing 2% (w/v) of Red-40, 2% (w/v) carboxymethylcellulose, 0.3% (w/v) Tween-20 (ambient temperature, deionized water).

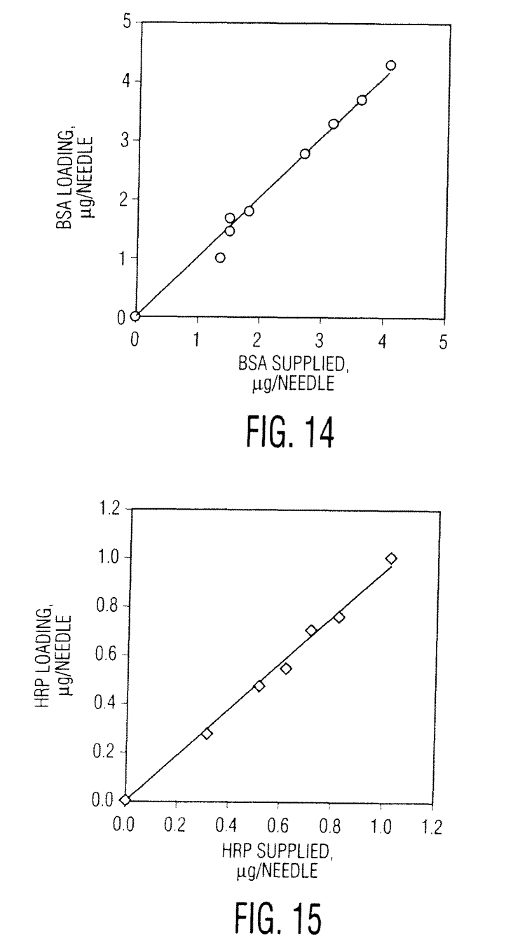

FIG. 14 illustrates dependence of BSA (bovine serum albumin) loading on a microneedle as determined by high performance liquid chromatography (HPLC) on the amount of BSA supplied in the fluid coating formulation to the same microneedle.

FIG. 15 illustrates dependence of horseradish peroxidase (HRP) loading on the microneedle as determined by HPLC on the amount of HRP supplied in the fluid coating formulation to the same microneedle.

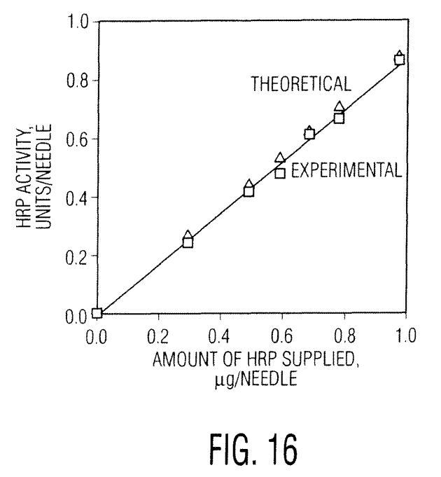

FIG. 16 illustrates an experimental enzymatic activity of HRP per microneedle versus the amount of HRP supplied in the fluid coating formulation to the same microneedle (squares, solid line). Theoretical activity calculated based on the amount of HRP supplied to the microneedle is also shown (triangles, dashed line).

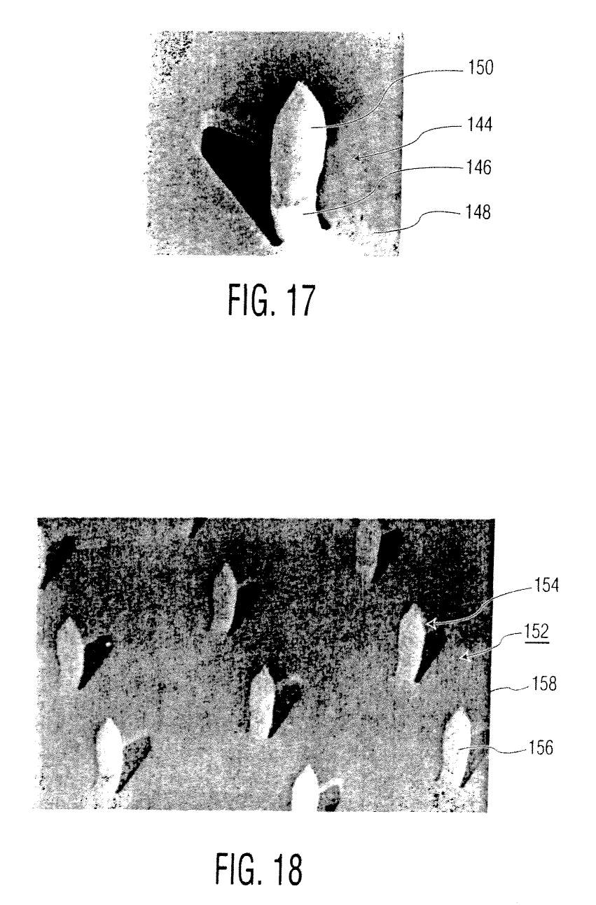

FIG. 17 illustrates a microphotograph scanning electron microscopy image of a coated microneedle 144 at a magnification of 83× with a coating of BSA loading at 1 μg per microneedle according to example 1 below. The underlying microneedle comprises a metal substrate 146 which is stamped from a metal substrate sheet 148 which forms the support from which the microneedle 144 extends. The microneedle 144 has a coating 150 with a biologically active compound formed by an apparatus and a method as described herein.

FIG. 18 is a microphotograph of a scanning electron microscopy image of an array 152 of microneedles 154 at a magnification of 34× and coated with a coating 156 in accordance with an embodiment of the present invention. The array 152 of microneedles are sheet metal stamped from and extend from a sheet metal substrate 158.

### EXAMPLE I

### Microneedle Coatings Containing BSA

A coating formulation was prepared containing 3% (w/v) of carboxymethylcellulose, sodium salt, 5% (w/v) of bovine serum albumin, and 0.3% (w/v) of polyoxyethylene sorbitan monolaurate (Tween 20) in deionized water. The coating process was performed using 741 MD-SS Dispense valve system (EFD, Inc., East Providence, R.I.), containing 3 mL barrel reservoir, PTFE lined dispensing tip (5I25TLCS-B, EFD, Inc., East Providence, R.I.) and ValveMate 7000 controller (EFD, Inc. East Providence, R.I.). The dispensing system allows delivering controlled amount of liquid varying the number of pulses and the volume corresponding to each pulse. A volumetric calibration of the dispenser was performed before and after each set of experiments to estimate the amount of protein contained in one pulse of the coating solution. Usually, twenty pulses of working solution were dispensed onto a plastic dish, mixed with 1 mL of 0.1× PBS, and analyzed using size exclusion high performance liquid chromatography (HPLC). The procedure was repeated in triplicates before and after experiment. Standard deviation was not exceeded 5-8%.

A stereo zoom microscope (STZ-45-BS-FR), with a 2.0 megapixel 1616×1216 digital camera (Caltex Scientific, Irvine, Calif.) and AM-311 Dino-Lite digital microscope with adjustable magnification from IOx to 200× (BIGC, Torrance, Calif.) were used to monitor the coating process.

An array containing 50 titanium microneedles (length—600 μm) was used in the coating process. A microneedle array was attached to lower surface of a horizontal stage on X-Y-Z micro positioning system using double-sided adhesive tape and the dispenser was set up in a vertical position on a ring stand. Using the X-, Y-, Z-control knobs, the microneedles were aligned over the dispenser-tip to assure proper insertion before the coating. The dispenser was purged with the formulation to remove air bubbles and to fill the tip up to level the liquid with the dispenser tip. Then a feed of a formulation was supplied corresponding to a single pulse resulting in the formation of a meniscus over the dispenser tip. The microneedle of the array was then brought into contact with the liquid, raised out, left on the air until the coating was visibly dry (FIG. 4). The process was then repeated until the feed was consumed (the formulation level is brought back to the upper level of the tip and the meniscus is removed).

The coating was then analyzed for the protein loading. The microneedle array was rinsed with 1 ml. of 0.1× phosphate-buffered saline (PBS) to dissolve the coating and the protein loading was quantified using size exclusion chromatography—Hitachi LaChrom Elite IIPLC system (Hitachi High Technologies America, Inc. San Jose, Calif.), equipped with L-213OHTA pump with degasser, L-2200 autosampler, L-2455 Diode array detector, L-2490 refractive index detector, EZChrom Elite Stand-Alone Software for Hitachi LaChrom Elite HPLC, and Ultrahydrogel 250 column with a guard column (Waters, Milford, Mass.). 0.1× PBS, containing 10% acetonitrile was used as a mobile phase with a flow rate of 0.75 mL/min and an injection volume of 0.095 mL. Aqueous solutions of BSA with known concentration were used to produce the calibration curve, which was then used to determine the amount of protein in the analyzed samples.

The experiments were repeated on other microneedles so that the number of pulses (feeds of solution supplied to the microneedle) was varied. The results were plotted as the actual amount of protein detected on the microneedle by HPLC versus the amount of protein supplied to the same microneedle calculated based on the volume of the solution supplied to the microneedle and protein concentration in the solution (FIG. 14). The results show linear correlation between the actual amount of protein coated on the microneedle and the amount of protein supplied to the same microneedle during the coating process, thus demonstrating the accuracy of the dosing method of the present invention. See FIG. 17.

### EXAMPLE 2

### Microneedle Coatings Containing Horseradish Peroxidase (HRP)

Coating experiments were performed as described in Example 1 except that HRP was used as a biologically active compound. The coating formulation contained 2% (w/v) of carboxymethylcellulose, sodium salt, 1.0% (w/v %) of HRP, 0.3% (w/v) of polyoxyethylene sorbitan monolaurate (Tween 20) in deionized water. The enzymatic activity of HRP was measured using 2,2′-Azino-bis(3-Ethylbenzthiazoline-6-Sulfonic Acid) as a substrate (Enzymatic Assay of peroxidase from horseradish, EC 1.11.1.7, Sigma Prod. No. P-6782). One unit of HRP oxidizes 1.0 mmole of 2,2′-azino-bis (3-ethylbenzthiazoline-6-sulfonic acid) per minute at pH 5.0 at 25 C. The absorbance ΔA_{4O5nm}/minute was used to calculate the maximum linear rate for both the test and blank.

The results of the HRP coating experiments (FIG. 15) also demonstrate linear correlation between the actual amount of protein coated on the microneedle and the amount of protein supplied to the same microneedle during the coating process. FIG. 16 also demonstrates that practically all of the enzymatic activity of HRP was maintained during the coating process.

It should be understood that modifications to the disclosed embodiments may be made by one of ordinary skill. The various embodiments disclosed herein are given by way of illustration and not limitation. The scope of the present invention is intended to be defined by the appended claims.

What is claimed is:

1. A method for coating a microneedle with a predetermined dose of biologically active compound comprising:
forming at least one coating reservoir of a liquid coating formulation comprising the predetermined dose of the biologically active compound, the amount of formulation in the at least one coating reservoir manifesting the predetermined dose being sufficient to form at least one layer of a coating on the microneedle and being substantially no more than the predetermined dose of the biologically active material; and
immersing the microneedle into the liquid formulation in the at least one coating reservoir to form the at least one layer of coating on the microneedle, the immersing for substantially consuming the liquid coating formulation in the at least one coating reservoir.

2. The method of claim 1 wherein the forming step includes feeding the liquid formulation to a receptacle at least once to form the at least one coating reservoir to form the predetermined dose.

3. The method of claim 1 wherein the step of forming the at least one reservoir includes providing the liquid formulation of the biologically active compound for coating the at least one microneedle and then feeding the provided liquid formulation to a receptacle at least once to form the at least one coating reservoir.

4. The method of claim 1 wherein the step of forming the at least one reservoir includes feeding a predetermined volume of the liquid coating formulation to a receptacle at least once with a predetermined concentration of said biologically active compound in said coating formulation.

5. The method of claim 1 including forming the liquid formulation as an aqueous formulation.

6. The method of claim 1 including forming the liquid formulation with a viscosity enhancer.

7. The method of claim 1 including forming the liquid formulation with a polymer viscosity enhancer.

8. The method of claim 1 including forming the liquid formulation with a water-soluble polymer.

9. The method of claim 1 including forming the liquid formulation with a water-soluble polymer selected from the group consisting of sodium carboxymethylcellulose, dextran, polyvinylpyrrolidone, polyphosphazene polyelectrolyte, and ethylcellulose.

10. The method of claim 1 including forming the liquid formulation with a therapeutic protein biologically active compound.

11. The method of claim 1 including forming the liquid formulation with a vaccine antigen biologically active compound.

12. The method of claim 1 including forming the liquid formulation with a biologically active compound that is a combination of a vaccine antigen and vaccine adjuvant.

13. The method of claim 12 where the vaccine adjuvant is a polyphosphazene adjuvant.

14. The method of claim 13 wherein the polyphosphazene adjuvant is sodium poly[di(carboxylatophenoxy)phosphazene] or sodium poly[di(carboxylatoethylphenoxy)phosphazene].

15. The method of claim 1 including forming the liquid formulation with a biologically active compound as a small drug.

16. The method of claim 1 including forming the liquid formulation with a surfactant.

17. The method of claim 1 including forming the liquid formulation with a slow release system.

18. The method of claim 1 including forming the liquid formulation with a slow release system comprising a microsphere, nanosphere, or liposome based system.

19. The method of claim 1 wherein said immersing step comprises immersing the at least one microneedle into the liquid formulation at least three times.

20. The method of claim 1 including providing the at least one microneedle formed from at least one of the materials selected from the group consisting of titanium, stainless steel, nitinol, water-soluble polymer, water-insoluble polymer, and silicon.

21. The method of claim 1 wherein the forming the at least one coating reservoir of a liquid coating formulation includes the step of feeding the formulation to the reservoir by one of gravity, a mechanical device, a vacuum, an electrical device and/or an electromechanical device.

22. The method of claim 1 wherein said immersing step comprises immersing the at least one microneedle with said liquid formulation at a predetermined depth of the at least one microneedle into the formulation in the at least one reservoir.

23. The method of claim 1 wherein the at least one microneedle has a tip and a base, the immersing step comprising immersing the at least one microneedle with the liquid formulation multiple times while gradually reducing the depth of immersion of the at least one microneedle into the liquid formulation in subsequent immersion steps to produce a coating whose thickness at the microneedle tip has a value that exceeds the value of the thickness at the microneedle base.

24. The method of claim 1 wherein the forming of the at least one reservoir comprises feeding the liquid formulation periodically to a reservoir receptacle at a feed rate sufficient to provide the amount of formulation in the reservoir manifesting the predetermined dose sufficient for forming the at least one layer of a coating on the microneedle.

25. The method of claim 1 wherein the forming of the at least one reservoir comprises feeding the liquid formulation periodically to a reservoir receptacle continuously at a rate that does not exceed the consumption of the formulation from the coating reservoir during the forming of the coating.

26. The method of claim 1 including the step of forming a plurality of the microneedle and forming an array of the microneedles, the immersing step comprising immersing the microneedles of the array into the at least one coating reservoir with an X-Y-Z positioning system.

27. The method of claim 1, wherein the step of forming the at least one coating reservoir of a liquid coating formulation includes providing more than one liquid formulation for a single coating.

28. The method of claim 1 wherein the step of forming at least one coating reservoir of a liquid coating formulation includes forming a plurality of coating reservoirs in a first array, said at least one microneedle comprising a plurality of microneedles in a second array, each microneedle of the second array corresponding to a different one of the reservoirs of the reservoir first array, the immersing step including immersing the plurality of said at least one microneedle simultaneously into the corresponding reservoir of the first array of reservoirs to perform simultaneous coatings of the plurality of microneedles.

29. A method for producing a coating on a plurality of microneedles, which coating contains a predetermined dose of biologically active compound comprising.
a) providing at least one array of microneedles and at least one coating reservoir, which coating reservoir is in fluid communication with at least one supply reservoir containing a liquid formulation of a biologically active compound;
b) feeding the liquid formulation from the at least one supply reservoir to the at least one coating reservoir substantially in an amount sufficient to form at least one layer of a coating on each microneedle of the at least one array, the at least one layer manifesting no more than the predetermined dose of the biologically active material for each microneedle of the at least one array;
c) immersing the microneedles of the array into the liquid formulation at least once to form the at least one layer of coating on each microneedle;
d) repeating steps (b) and (c) as needed to consume substantially the entire amount of the liquid formulation manifesting the no more than the predetermined dose fed to the at least one coating reservoir.

30. The method of claim 29 wherein the microneedles of the array each have a base and are located in a given spacing from each other, the method including the step of providing a cover over the at least one coating reservoir, the cover having a plurality of through orifices equal in number to the number of the microneedles in the at least one microneedle array and located in said given spacing aligned with a corresponding one of said at least one reservoir, said cover being arranged for allowing the immersion of the microneedles into the liquid formulation through the orifices, and for prohibiting the contacting between the base of the microneedle array and the liquid formulation.

31. A system for coating a microneedle with a predetermined dose of biologically active compound comprising:
a first apparatus including at least one coating reservoir of a liquid coating formulation comprising the predetermined dose of the biologically active compound, the amount of formulation in the at least one coating reservoir manifesting the predetermined dose being sufficient to form at least one layer of a coating on the microneedle and being substantially no more than the predetermined dose of the biologically active material; and
a second apparatus for immersing the microneedle into the liquid formulation in the at least one coating reservoir to form the at least one layer of coating on the microneedle, the immersing for substantially consuming the liquid coating formulation in the at least one coating reservoir.

32. The system of claim 31 wherein the first apparatus includes a liquid formulation feeding arrangement and a receptacle, the first apparatus for feeding a measured predetermined volume of the liquid formulation to the receptacle at least once to form the at least one coating reservoir, the predetermined volume manifesting the predetermined dose.

33. The system of claim 31 wherein the first apparatus at least one reservoir includes a receptacle and a further reservoir for providing the liquid formulation of the biologically active compound for coating the at least one microneedle and including a fluid feeding device for feeding the provided liquid formulation from the further reservoir to the receptacle at least once to form the at least one coating reservoir.

34. The system of claim 31 wherein the wherein the first apparatus includes a fluid coating receptacle for receiving the liquid formulation of the biologically active compound for forming the at least one coating reservoir and including a liquid metering arrangement for feeding the liquid formulation to the receptacle at least once.

35. The system of claim 31 including a first computer programmed control for feeding the formulation to a receptacle to form the at least one reservoir and a second computer programmed control for said immersing for controlling an x-y-z manipulation device coupled to at least one of said first and second apparatuses for said immersing.

36. The system of claim 31 including an array of said microneedle, and wherein the first apparatus comprises an array of said at least one coating reservoir and the second apparatus comprises an arrangement for manipulating the array of said microneedle for said immersing into said array of said at least one coating reservoir.

37. The system of claim 31 wherein the first and second computer controls are coupled to control the time of the feeding of the formulation with the control of the time of the immersing.

38. In a system for coating a microneedle with a predetermined dose of biologically active compound, the system including an array of microneedles each for receiving a predetermined dose of a biologically active compound, the array of microneedles being disposed in a predetermined relative spacing, a reservoir system for use with the microneedle array comprising:
an array of receptacles each forming a reservoir for receiving a coating liquid formulation of the biologically active compound, the formulation for coating the microneedles, the array of receptacles corresponding to the array of microneedles, each receptacle for simultaneously receiving a corresponding different microneedle of the array of microneedles, the array of receptacles being spaced in said predetermined relative spacing for said receiving.

39. The system of claim 38 wherein the microneedles of the array each having a given transverse dimension w and spaced from the next adjacent microneedle a distance L to form an array of microneedles, the receptacles each having a diameter of D which is less than 2L+w.

40. The system of claim 38 wherein the microneedles and the receptacles are circular cylindrical.

41. A method for coating a microneedle with a predetermined dose of biologically active compound comprising:
forming at least one coating reservoir of a liquid coating formulation comprising the predetermined dose of the biologically active compound, the volume of the formulation in the at least one coating reservoir manifesting the predetermined dose being sufficient to form at least one layer of a coating on the microneedle and being substantially no more than the predetermined dose of the biologically active material; and
immersing the microneedle into the liquid formulation in the at least one coating reservoir to form the at least one layer of coating on the microneedle, the immersing for substantially consuming the liquid coating formulation in the at least one coating reservoir.

42. The method of claim 41 including feeding a portion of the volume of the formulation into a receptacle, immersing the microneedle into the receptacle to form a partial coating of the biologically active compound formulation from the portion, repeating the feeding step in increments as necessary until the entire volume of the formulation manifesting the predetermined dose has been fed to the receptacle, and repeating the immersing step after each feeding step until substantially all of the portions are consumed.
